(19) United States
(12) Patent Application Publication
(10) Pub. No.: US 2018/0242198 A1
(43) Pub. Date: Aug. 23, 2018

(54) MOBILE COMMUNICATION NETWORK SYSTEM AND CONTROL METHOD THEREOF

(71) Applicant: ELECTRONICS AND TELECOMMUNICATIONS RESEARCH INSTITUTE, Daejeon (KR)

(72) Inventor: Young Il CHOI, Daejeon (KR)

(21) Appl. No.: 15/902,067

(22) Filed: Feb. 22, 2018

(30) Foreign Application Priority Data
Feb. 23, 2017 (KR) 10-2017-0024401
Feb. 20, 2018 (KR) 10-2018-0020071

(51) Int. Cl. H04W 28/18; H04W 12/06; H04L 29/12

(52) U.S. Cl. CPC H04W 28/18; H04W 80/04; H04L 61/2007; H04W 12/06

(57) ABSTRACT

A mobile communication network system includes a default network slice; at least one core network slice added according to a supporting service; andDeletedTextsat least one service operator network slice added according to a service operator in the core network slice. The core network slice is determined according to a service type required by user equipment, and the service operator network slice is determined by the core network slice.

### CROSS-REFERENCE TO RELATED APPLICATION

This application claims priority to and the benefit of Korean Patent Application Nos. 10-2017-0024401 and 10-2018-0020071, filed on Feb. 23, 2017 and Feb. 20, 2018, respectively, in the Korean Intellectual Property Office, the entire contents of which are incorporated herein by reference.

### BACKGROUND OF THE INVENTION

### 1. Field of the Invention

The present invention relates to a network configuration. More particularly, the present invention relates to a mobile communication network system and a control method thereof.

### 2. Description of Related Art

The 4^{th} generation mobile communication, which is standardized in the 3GPP (3rd Generation Partnership Project) and commercialized at present, is a network for supporting a large capacity mobile Internet service and consists of a LTE (Long Term Evolution) that is a wireless section and an EPC (Evolved Packet Core) that is a core network. The EPC consists of SGW (Serving Gateway) and PGW (Packet Data Network Gateway) for data transfer, and MME (Mobility Management Entity) for mobility support. The GTP protocol is used to transmit data and signaling between nodes in the EPC.

Although the 4th generation mobile communication network based on such a structure has a structure suitable for the large capacity mobile Internet service, the fourth generation mobile communication network has limitations in supporting a large scale thing Internet service and a low latency internet service, which are expected to be provided in the 5th generation mobile communication network.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a network slice-based mobile communication network system and a control method thereof having advantages of configuring and supporting a logical dedicated network suitable for a characteristic of a service.

According to an embodiment of the present invention, a mobile communication network system includes a default network slice; at least one core network slice added according to a supporting service; and DeletedTextsat least one service operator network slice added according to a service operator in the core network slice, wherein the core network slice is determined according to a service type required by user equipment, and the service operator network slice is determined by the core network slice.

In a case where the user equipment requires a first service and a second service, a first core network slice according to a type of the first service and a second core network slice according to a type of the second service may be configured.

The default network slice may determine a core network slice corresponding to a service type required by the user equipment among a plurality of core network slices, and the core network slice may determine a service operator network slice corresponding to the service type required by the user equipment among a plurality of service operator network slices.

The default network slice may perform a user equipment management function of authenticating whether a network access of the user equipment is allowed when the user equipment firstly accesses, a network slice selection function of selecting a network slice type to be used by the user equipment, and an authentication function of allocating an ID and an IP address to be used by the user equipment.

In this case, the default network slice may select one core network slice from among a plurality of core network slices according to a service type required by the user equipment that accesses, determine a temporary ID with respect to the user equipment according to identification information of the selected core network slice, allocate an IP address to be used when the user equipment transmits a data packet, and transmit an access permission message to the user equipment.

The access permission message may include identification information of the default network slice to which the user equipment is accessed, identification information of the selected core network slice, the temporary ID, the IP address, and authentication related information.

The core network slice may perform a user equipment management and authentication function of managing the user equipment that accesses and authenticating a service use authorization, and, in a case where the user equipment has the service use authorization, a network slice selection function of selecting one service operator network slice from a plurality of service operator network slices.

The service operator network slice may include a specific control plane network function unit performing a session and QoS (Quality of Service) control and a specific user plane network function unit performing a data transfer.

According to a data traffic path setting request of the core network slice for the user equipment, the specific control plane network function unit may set a data traffic path with the specific user plane network function unit based on location information of a base station to which the user equipment is accessed.

A core network slice supporting the same service may be changed according to a movement of the user equipment.

According to another embodiment of the present invention, a control method of a mobile communication network system includes a control device that is a default network slice of the mobile communication network system determining a network slice corresponding to a service type required by a user equipment; and the control device transmitting a message including identification information of the selected network slice to the user equipment, wherein the network slice includes a core network slice corresponding to the service type and further includes a service operator network slice in the core network slice.

The determining of the network slice may include the control device authenticating whether a user of the user equipment is a subscribed allowed to access; and in a case where the user of the user equipment is the subscribed allowed to access, the control device selecting a core network slice corresponding to a service type required by the user equipment.

The transmitting of the message to the user equipment may include the control device determining a temporary ID of the user equipment according to identification information of the selected core network slice and allocating an IP address to be used when the user equipment transmits a data packet; and the control device transmitting a message including identification information of the default network slice to which the user equipment is accessed, identification information of the selected core network slice, the temporary ID, the IP address, and authentication related information.

The control method may further include, before the determining of the network slice, in a case where identification information of the user equipment that accesses is the temporary ID and the identification information of the default network slice provided from the user equipment is not identical to the identification information of the default network slice corresponding to the control device, the control device receiving a service request message with respect to the user equipment from the base station, DeletedTexts wherein a network slice with respect to the user equipment is re-determined.

According to another embodiment of the present invention, a control method of a mobile communication network system includes a control device corresponding to a core network slice of the mobile communication network system authenticating whether a user equipment has a service use authorization; in a case where the user equipment has the service use authorization, the control device selecting one service operator network slice from a plurality of service operator network slices; the control device requesting a data traffic path setting with respect to the user equipment from the selected service operator network slice; and the control device transmitting information about a data traffic path set according to a request to the user equipment.

The service operator network slice may include a specific control plane network function unit performing a session and QoS control and a specific user plane network function unit performing a data transfer.

The requesting of the data traffic path setting may include the specific control plane network function unit of the service operator network slice receiving a data traffic path setting request; the specific control plane network function unit selecting one specific user plane network function unit from a plurality of specific user plane network function units based on location information of a base station to which the user equipment is accessed; and the specific control plane network function unit setting a data traffic path with the selected specific user plane network function unit.

### BRIEF DESCRIPTION OF THE DRAWINGS

FIG. 1 is a diagram of a conventional mobile communication network.

FIG. 2 is a diagram of a structure of a mobile communication network according to an exemplary embodiment of the present invention.

FIG. 3 is a diagram of a structure of a network slice according to an exemplary embodiment of the present invention.

FIG. 4 is a flowchart of a first procedure of setting a data traffic path in a control method according to an exemplary embodiment of the present invention.

FIG. 5 is a flowchart of a second procedure of reselecting a network slice in a control method according to an exemplary embodiment of the present invention.

FIG. 6 is a flowchart of a third procedure that is a service activation procedure in a control method according to an exemplary embodiment of the present invention.

FIG. 7 is a diagram of a structure of a control device of a mobile communication network system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification and claims, when a portion is referred to as including a constituent element, it means that the portion does not exclude another constituent element but may further include another constituent element unless specifically stated otherwise.

Throughout the specification, a terminal may refer to user equipment (UE), a mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), etc. and may include all or some of functions of the UE, the MS, the MT, the AMS, the HR-MS, the SS, the PSS, the AT, etc.

Also, the base station (BS) may refer to a node B, an evolved node B (eNB), gNB, an advanced base station (ABS), a high reliability base station (HR-BS), an access point (AP), a radio access station (RAS), a base transceiver station (BTS), an MMR (mobile multihop relay)-BS, a relay station (RS) acting the base station, a relay node (RN) acting the base station, an advanced relay station (ARS) acting the base station, a high reliability relay station (HR-RS) acting the base station, a small base station [a femto BS, a home node B (HNB), a home eNodeB (HeNB), a pico base station (pico BS), a macro BS, a micro BS, etc.], etc, and may include all or some of functions of the NB, the eNB, the gNB, the ABS, the AP, the RAS, the BTS, the MMR-BS, the RS, the RN, the ARS, the HR-RS, the small base station, etc.

In the present specification, the expression recited in the singular may be construed as singular or plural unless the expression “one” or “single”, etc. is used.

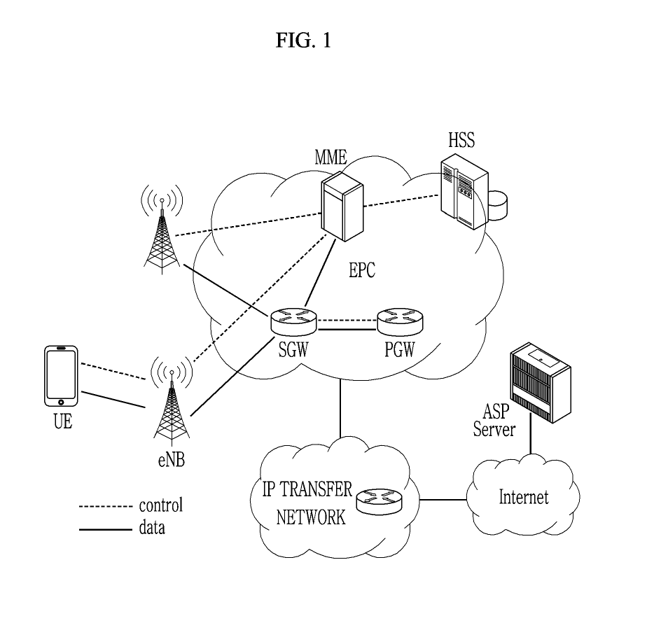

FIG. 1 is a diagram of a conventional mobile communication network.

As shown in the attached FIG. 1, the conventional mobile communication network (e.g.: 4G mobile communication network) consists of a LTE (Long Term Evolution) that is a wireless section and an EPC (Evolved Packet Core) that is a core network. The EPC consists of SGW (Serving Gateway) and PGW (Packet Data Network Gateway) for data transfer, and MME (Mobility Management Entity) for mobility support.

The conventional mobile communication network based on such a structure provides a large capacity mobile Internet service and has limitations in providing various services.

The mobile communication network system according to an exemplary embodiment of the present invention may be applied to various mobile communication networks. For example, the mobile communication network system may be applied to 5G and later mobile communication networks. In an exemplary embodiment of the present invention, for convenience of description, although an example in which the mobile communication network system is applied to a 5G-based mobile communication network is described, an exemplary embodiment of the present invention is not limited thereto and the mobile communication network system may be applied to various mobile communication networks.

In the mobile communication network (e.g.: 5G mobile communication network) according to an exemplary embodiment of the present invention, a network control plane and a data transfer plane are separated. The mobile communication network is constructed based on a network function other than a network node. Also, unlike the conventional mobile communication network (e.g.: 4G network), in an exemplary embodiment of the present invention, a logical dedicated network suitable for a characteristic of each service is configured so as to effectively support various services such as a large scale thing Internet service, a large capacity mobile Internet service (or named as a large scale IoT (Internet of Thing) terminal service), a low latency Internet service, etc.

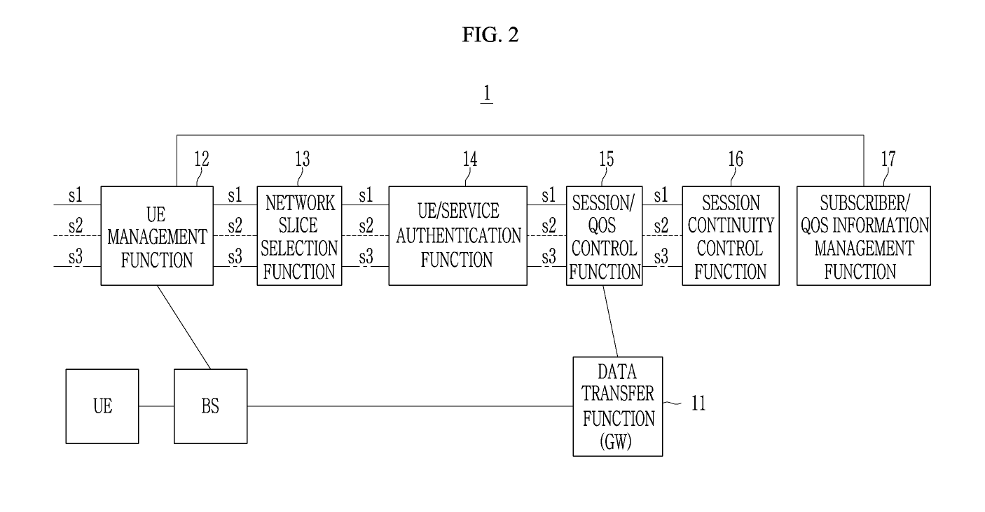

FIG. 2 is a diagram of a structure of a mobile communication network according to an exemplary embodiment of the present invention.

Upon reviewing a structure of a mobile communication network system according to an exemplary embodiment of the present invention in terms of a function, as shown in the attached FIG. 2, a mobile communication network system, i.e. a core network system 1, a BS (base station), and UE (user equipment) configures the mobile communication network.

The UE uses a service (hereinafter referred to as an Internet service for convenience of description) by using an IP address assigned in the core network system 1. The UE performs signal processing such as access authentication, radio channel configuration, etc. on the mobile communication network so as to transmit and receive data of the Internet service.

The base station (BS) sets a radio channel for control and data transmission with the UE, transfers a message (e.g.: NAS (non-access stratum) message) between the UE and the core network system 1, and performs a function of transmitting and receiving a data packet through a path set in the core network system 1.

Upon reviewing the structure of the mobile communication network system according to an exemplary embodiment of the present invention in terms of a function, as shown in the attached FIG. 2, the core network system 1 includes a data transfer function 11, a UE management function 12, a network slice selection function 13, an UE and service authentication function 14, a session and QoS (Quality of Service) control function 15, a session continuity control function 16, and a subscriber and QoS information management function 17. Service interface types S1, S2, and S3 provided in each function represent unit elements of a network function provided in each function. For example, the service interface types S1, S2, and S3 may be unit elements of the network function supporting a large scale thing Internet service, a large capacity mobile Internet service, and a low latency Internet service, respectively, but the present invention is not limited thereto.

The data transfer function 11 functions a data transfer plane (or a user data plane) of the core network system 1 and performs forwarding and routing functions of a data packet with respect to the UE. The data transfer function 11 corresponds to a gateway (GW).

The UE management function 12 functions a gateway of the core network system 1. Specifically, the UE management function 12 searches for subscriber information with respect to the UE, manages a location of a base station (BS) accessed by the UE and allocates an IP (Internet Protocol) address to be used by the UE.

The network slice selection function 13 selects a network slice type to be used by the UE and assigns an ID (identity) with respect to a network slice in charge of the corresponding slice type to the UE. The network slice will be described in more detail later.

The UE and service authentication function 14 performs a function of authenticating whether it is possible for the UE to access the core network system 1, the UE is authorized to use the assigned network slice, etc.

The session and QoS control function 15 sets a traffic path with respect to user data between the base station (BS) and a gateway.

The session continuity control function 16 performs a function of maintaining and controlling a session formed with the UE.

The subscriber and QoS information management function 17 performs a function of managing information relating to service, authentication, QoS, etc. with respect to a subscriber.

The core network system 1 according to an exemplary embodiment of the present invention may be configured to perform the functions 11-17 as described above, and each function may be a constituent element consisting of hardware and/or software configured to perform the corresponding function or a combination thereof. Hereinafter each function is named as a function unit. That is, the core network system 1 includes the data transfer function unit 11, the UE management function unit 12, the network slice selection function unit 13, the UE and service authentication function unit 14, the session and QoS control function unit 15, the session continuity control function unit 16, and the subscriber and QoS information management function unit 17.

In an exemplary embodiment of the present invention, a network slice represents a virtual network supported to efficiently perform various service types provided in the mobile communication network according to an exemplary embodiment of the present invention, and constructed by placing unit elements of a network function to be optimized to perform each of services. The network slice may be configured by modularizing the functions as described above.

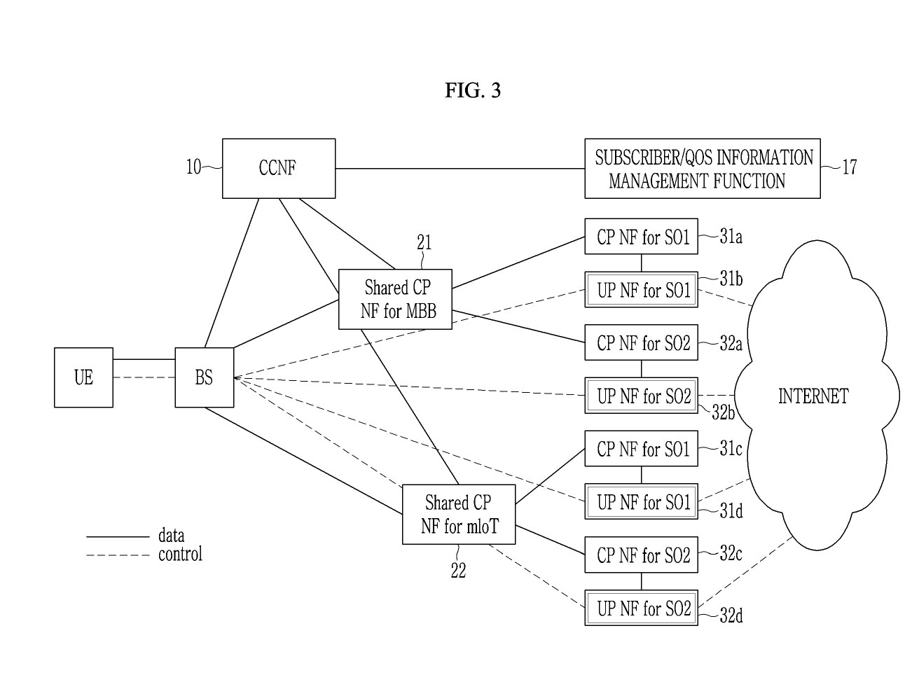

FIG. 3 is a diagram of a structure of a network slice according to an exemplary embodiment of the present invention.

Network slices for supporting a large capacity Internet service, a large capacity mobile Internet service, and a low latency Internet service aimed by the mobile communication network according to an exemplary embodiment of the present invention are provided, but the present invention is not limited thereto.

The core network system 1 constitutes a logical dedicated network suitable for a characteristic of each service, and a network slice that is the logical dedicated network includes a CCNF (common control network function) unit 10, shared control plain network function units 21 and 22, and specific network function units 31a, 31b, 32a, 32b, 31c, 31d, 32c, and 32d.

The network slice that is the logical dedicated network is configured for each service type to efficiently perform various service types. Network slice types include a default network slice used as default for management of user equipment and a network slices for services supporting various services. The default network slice includes a CCNF unit. The network slices for services include shared control plain network function units and specific network function units.

A specific network function is configured by being separated into a control plain and a user plain. That is, the specific network function unit is separated into a specific control plane network function unit and a specific user plane network function unit. In each network slice, the specific network function may be configured as an independent network slice according to a service operator. For example, the specific network function may be configured as specific control plane network function units corresponding to a first operator (for convenience of description, hereinafter named as the “first specific control plane network function units 31a and 31c”), specific user plane network function units corresponding to the first operator (for convenience of description, hereinafter named as the “first specific user plane network function units 31b and 31d”), specific control plane network function units corresponding to a second operator (for convenience of description, hereinafter named as the “second specific control plane network function units 32a and 32c”), specific user plane network function units corresponding to the second operator (for convenience of description, hereinafter named as the “second specific user I plane network function units 32b and 32d”), etc.

The shared control plain network function units include the shared control plain network function unit 21 for a first service and the shared control plain network function unit 22 for a second service. In this regard, the first service may represent a large capacity mobile Internet service, and the second service may represent a low latency Internet service.

The shared control plain network function unit 21 for the first service (for convenience of description, hereinafter named as the first shared control plain network function unit 21) is shared by the network slices 31a, 31b, 32a, and 32b configured for each service operator, and the shared control plain network function unit 22 for the second service (for convenience of description, hereinafter named as the second shared control plain network function unit 22) is shared by the network slices 31c, 31d, 32c, and 32d configured for each service operator.

The network slice configured in correspondence to a service type may be named as a “core network slice” for convenience of description, and the network slice configured for each service operator in the core network slice may be named as a “service operator network slice”.

For example, the first shared control plain network function unit 21, the first specific control plane network function units 31a, the first specific user plane network function units 31b, the second specific control plane network function units 32a, and the second specific user plane network function units 32b form a core network slice according to a first service type. And in the core network slice according to the first service type, the first specific control plane network function units 31a and the first specific user plane network function units 31b form a service operator network slice with respect to the first operator, and the second specific control plane network function units 32a and the second specific user plane network function units 32b for a service operator network slice with respect to the second operator.

Also, the second shared control plain network function unit 22, the first specific control plane network function unit 31c, the first specific user plane network function unit 31d, the second specific control plane network function unit 32c, and the second specific user plane network function unit 32d form a core network slice according to a second service type. In the core network slice according to the second service type, the first specific control plane network function unit 31c and the first specific user plane network function unit 31d form a service operator network slice with respect to the first operator, and the second specific control plane network function unit 32c, and the second specific user plane network function unit 32d form a service operator network slice with respect to the second operator.

The CCNF unit 10 performs UE access authentication and selects a network slice (a core network slice) for each service type optimized to the UE. Specifically, the CCNF unit 10 authenticates whether a network access of the UE is allowed when the UE firstly accesses the core network system, selects a network slice type to be used by the UE, and performs a function of allocating an ID and an IP address to be used by the UE to the UE. To this end, the CCNF unit 10 is a VNF (Virtual Network Function) configured to include the UE management function unit 12, the network slice selection function unit 13, and the UE and service authentication function (for convenience of description, named as an “authentication function unit 14”) of FIG. 1. The network slice for each service type is controlled by the CCNF unit 10.

The shared control plain network function units 21 and 22 perform UE management and UE service authentication and select network slices for each service operator (service operator network slices). To this end, the CCNF unit 10 is a VNF configured to include the UE management function unit 12, the network slice selection function unit 13, and the UE and service authentication function (for convenience of description, named as an “authentication function unit 14”) of FIG. 1.

The specific control plane network function units 31a, 32a, 31c, and 32c of the specific network function unit perform session and QoS control. To this end, the specific control plane network function units 31a, 32a, 31c, and 32c are VNFs configured to include the session and QoS control function 15 and the session continuity control function 16 of FIG. 1. For convenience of description, the session and QoS control function 15 and the session continuity control function 16 may be collectively named as a “session control function” and a reference numeral “15” denotes the session control function for convenience of illustration.

The specific user plane network function units 31b, 32b, 31d, and 32d perform data transfer. To this end, the specific user plane network function units 31b, 32b, 31d, and 32d are VNFs configured to include the data transfer function unit 11 of FIG. 1.

The CCNF unit 10 may be installed in plural and operate according to a policy such as a load distribution and an arrangement for each region. In this case, separate IDs are assigned to CCNF units. For example, the CCNF unit 10 interacting with at least one base station may be arranged for each region, and an ID may be assigned to the CCNF unit 10 arranged for each region.

The network slices for each service type may also be installed in plural and operate according to the policy such as the load distribution and the arrangement for each region. In this case, separate IDs are assigned to the network slices. For example, IDs are assigned to the network slices for each service type that are the core network slices, and IDs are assigned to the network slices for each operator that are the service operator network slices. The network slices for each service type are controlled by one CCNF unit.

Next, based on the network slice based core network system having the above structure, a control method of the network system according to an exemplary embodiment of the present invention is described.

First, in an exemplary embodiment of the present invention, a control method of a first procedure of registering a subscriber UE, selecting a network slice, and setting a user data traffic path is described.

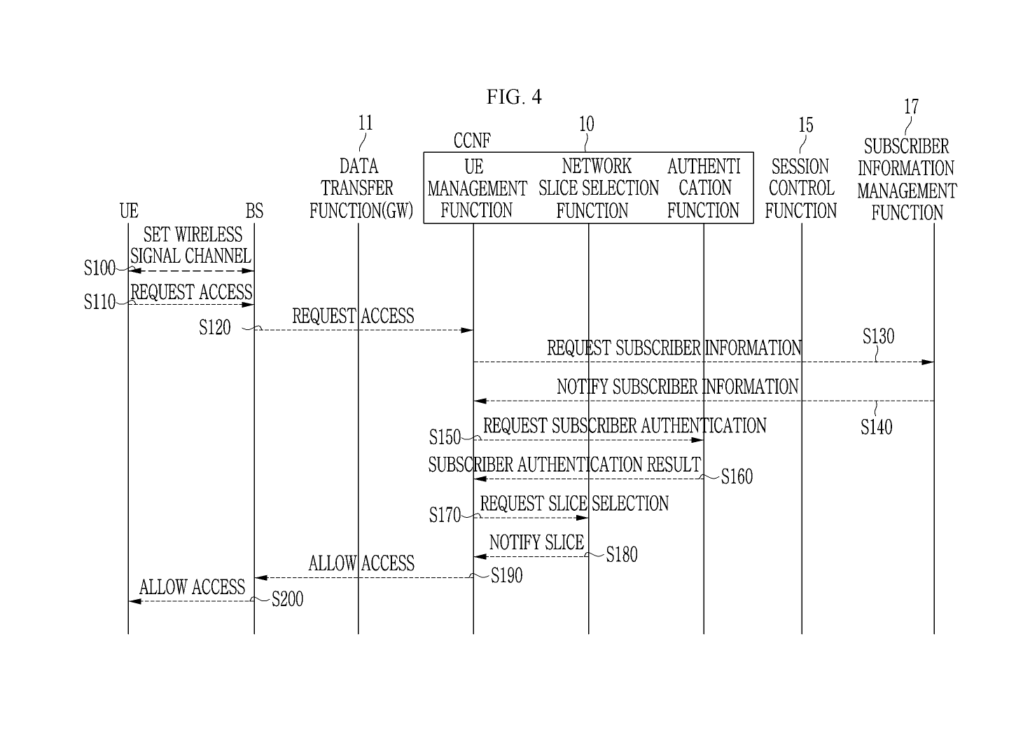

FIG. 4 is a flowchart of a first procedure of setting a data traffic path in a control method according to an exemplary embodiment of the present invention.

In a case where a user powers the UE on and accesses a network slice based core network system as shown in the attached FIG. 3, in an attach request processing procedure used when the UE first accesses the core network system, a mutual authentication between the UE and the core network system, an assignment of an ID of the UE, an allocation of a network slice ID to be used by the UE, an allocation of an IP address to be used by user equipment (UE) for data traffic transmission, a registration of a base station to which user equipment (UE) is accessed, etc. are performed.

Specifically, as shown in FIG. 4, when the UE is in a power on state, the UE receives a wireless signal from a base station (BS) nearby and synchronizes with a wireless channel (S100).

The UE transmits an attach request message including UE information (e.g. an UE ID, an UE type, etc.) in order to access the core network system to the base station (BS) (S110).

The BS searches for an address of the CCNF unit 10 of the core network system to manage the UE after receiving the attach request message, and transfers the attach request message to the CCNF unit 10 having the corresponding address (S120).

The CCNF unit 10 requests UE subscriber information from the subscriber and QoS information management function unit 17 after receiving the attach request message (S130). The CCNF unit 10 receives the subscriber information from the subscriber and QoS information management function unit 17 (S140) and then generates a key necessary for mutual authentication and service authentication and confirms whether a subscriber of the UE is a subscriber allowed to access the core network system based on the generated key (S150 and S160). Subscriber authentication processing is performed through interaction between an UE management function and an authentication function. At this time, if the subscriber of the UE is not the subscriber allowed to access the core network system, the CCNF unit 10 transmits an attach failure message to the BS.

Meanwhile, if the subscriber of the UE is the subscriber allowed to access the core network system, the CCNF unit 10 confirms a service type optimized to the UE and determines a network slice type to be used by the UE (S170), and selects a network slice (a core network slice) managed by itself in correspondence to the determined network slice type (S180). Network slice selection processing is performed through interaction with the UE management function and a network slice selection function.

The CCNF unit 10 determines a temporary ID number Temp ID to be used by the UE using an ID of the selected network slice, allocates an IP address to be used when the UE transmits a data packet, to the UE, and then transmits an attach permission message including information (Temp ID, the IP address, the authentication key, the ID of the CCNF unit 10 CCNF ID, and the ID of the selected network slice) to the BS (S190).

The BS transfers the received attach permission message to the UE through a wireless channel (e.g.: 5G RAN) (S200). The UE confirms and manages the information such as Temp ID to be used by the UE, the IP address, the authentication key, the accessed CCNF ID, the ID of the selected network slice, etc. after receiving the attach permission message.

Next, a control method of a second procedure of reselecting a new network slice to be used after the UE accesses the core network system and moves away locally is described.

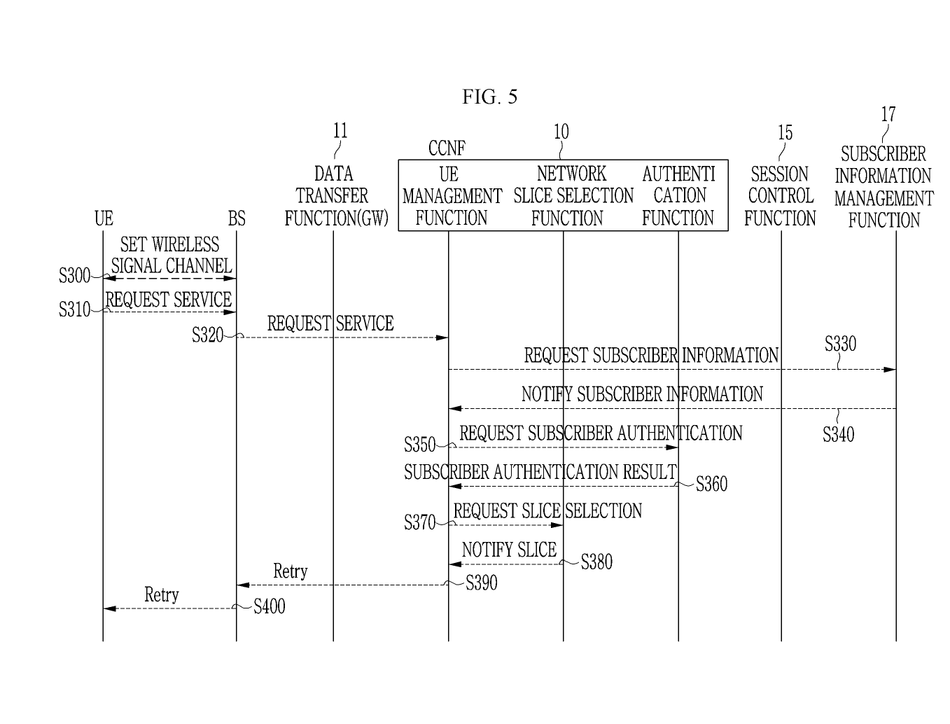

FIG. 5 is a flowchart of a second procedure of reselecting a network slice in a control method according to an exemplary embodiment of the present invention.

After a user powers the UE on, accesses a core network system and then moves away locally, when an application service is executed in the UE and thus data traffic to be transmitted to the core network system occurs, as shown in FIG. 5, the UE sets a signal channel in synchronization with a wireless link with the BS (S300), and generates a service request message including data traffic setting related information received in an initial access procedure before moving away, i.e. a temporary ID of the UE Temp ID, an authentication key, an accessed CCNF ID, a network slice ID, etc. and transmits the service request message to the BS (S310).

The BS confirms an ID of the UE in the service request message after receiving the service request message. If the ID of the UE is an IMSI (International Mobile Subscriber Identity), the BS transmits an error message to the UE. If the ID of the UE is the temporary ID Temp ID, the BS confirms the CCFN ID to which the UE is accessed in the service request message. If the CCFN ID to which the UE is accessed and a CCNF ID interacting with the BS are not the same, the BS transfers the service request message to the CCNF unit 10 interacting with the BS (S320).

The CCNF unit 10 receives the service request message and recognizes that a controlled CCNF unit was changed due to a movement of the UE. The CCNF unit 10 selects a new network slice to be used by the UE in a region to which the UE moved and prepares for notification. To this end, the CCNF unit 10 requests UE subscriber information from the subscriber and QoS information management function unit 17 (S330).

The CCNF unit 10 receives the subscriber information from the subscriber and QoS information management function unit 17 (S340) and then generates a key necessary for UE authentication and service authentication and confirms whether a subscriber of the UE is a subscriber allowed to access the core network system based on the generated key (S350 and S360). At this time, if the subscriber of the UE is not the subscriber allowed to access the core network system, the CCNF unit 10 transmits a service denial message to the BS.

Meanwhile if the subscriber of the UE is the subscriber allowed to access the core network system, the CCNF unit 10 confirms a service type optimized to the UE and determines a network slice type to be used by the UE (S370), and selects a network slice (a core network slice) managed by itself in correspondence to the determined network slice type (S380).

The CCNF unit 10 determines a new temporary ID Temp ID to be used by the UE using the selected network slice ID, allocates an IP address to be used when the UE transmits a data packet, to the UE, and transmits a retry message including information to the BS (S390).

The BS transfers the received retry message to the UE (S400). The UE receives the retry message and then confirms and manages information such as the new temporary ID to be used by the UE, the IP address to be used by the UE, an authentication key, an new accessed CCNF ID, a newly selected network slice ID, etc.

Next, a third procedure in which the UE is activated to use Internet is described.

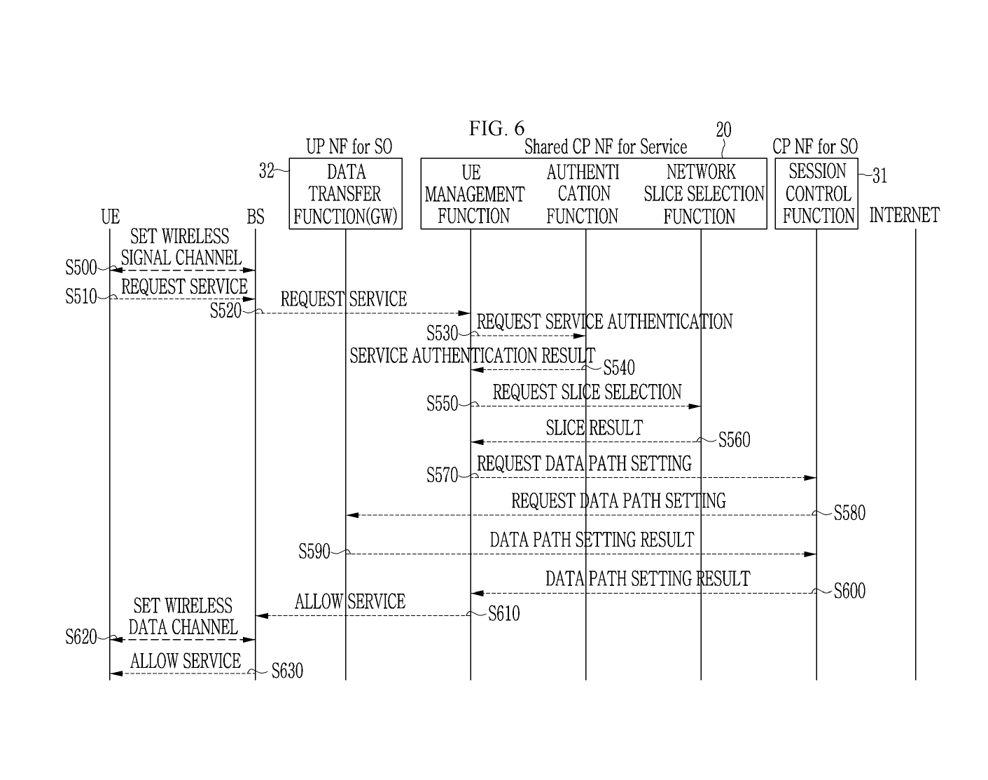

FIG. 6 is a flowchart of a third procedure that is a service activation procedure in a control method according to an exemplary embodiment of the present invention.

When a user powers the UE on and accesses a core network system, and then an application service is executed in the UE and data traffic to be transmitted to a mobile communication network occurs, as shown in FIG. 6, the UE sets a signal channel in wireless link synchronization with the BS (S500), generates a service request message including a temporary ID Temp ID of the UE, an authentication key, an accessed CCNF ID, an allocated network slice ID, etc., and transmits the service request message to the BS (S510).

The BS confirms an UE ID in the service request message after receiving the service request message. If the UE ID is an IMSI, the BS transmits an error message to the UE, and, if the UE ID is the temporary ID Temp ID, the BS confirms the CCNF ID to which the UE is accessed in the service request message. If the CCNF ID to which the UE is accessed and a CCFN ID interacting with the BS are the same, the BS searches for an address of the network slice ID allocated to the UE and transfers the service request message to the found address (S520). The found address is an address corresponding to a shared control plain network function unit configuring a network slice corresponding to the network slice ID allocated to the UE and specifically is an address of a VNF performing an UE management function of the shared control plain network function unit.

The shared control plain network function unit 20 that received the service request message confirms if the shared control plain network function unit 20 has UE subscriber information. If the shared control plain network function unit 20 has no UE subscriber information, the shared control plain network function unit 20 (in particular, an UE management function unit) calls a subscriber information request API provided in a CCNF unit and obtains the UE subscriber information. The shared control plain network function unit 20 confirms if the UE is authorized to use a network slice service based on the UE subscriber information (S530 and S540). For example, the UE management function of the shared control plain network function unit 20 transfers an authentication key in the service request message to an authentication function, inquire whether the UE is authorized to use, and determines if the UE is authorized to use the network slice service based on an authentication result thereof.

The shared control plain network function unit 20 transmits a service denial message to the BS if the UE is not authorized to use the network slice service. If the UE is authorized to use the network slice service, a shared control plain network function unit (in particular, a network slice selection function) determines which network slice of a service operator (a service operator network slice) is to be used by the UE (S550 and S560). The network slice selection function of the shared control plain network function unit 20 selects the specific control plane network function unit 31 of an arbitrary service operator to process user data traffic based on location information of the BS.

The shared control plain network function unit 20 requests a data path setting from the selected specific control plane network function unit 31 (S570). That is, the UE management function of the shared control plain network function unit 20 calls a path setting request API provided by a session and QoS control function that is a VNF of the selected specific control plane network function unit 31 based on information such as an UE ID, an UE IP address, a BS ID, etc, and requests a path setting of the user data traffic for performing a service request of the UE.

The session and QoS control function of the specific control plane network function unit 31 selects a gateway performing data transfer, i.e. the specific user plane network function unit 32, based on location information of the BS, transmits a path setting request message to the selected specific user plane network function unit 32, and instructs a user data traffic path setting between the BS and the gateway 32 (S580).

A data transfer function of the specific user plane network function unit 32 receives the path setting request message and then sets a user data traffic path with the BS, and transfers a result thereof to the session and QoS control function of the specific control plane network function unit 31 through a path setting response message (S590).

The session and QoS control function of the specific control plane network function unit 31 receives the path setting response message and then notifies a path setting result to the UE management function of the shared control plain network function unit 20 (S600).

The UE management function of the shared control plain network function unit 20 confirms a call result with respect to the path setting request API provided by the session and QoS control function of the specific control plane network function unit 31, if the path setting is completed, and transmits information about the user data traffic path included in a service permission message to the BS (S610).

The BS receives the service permission message and then sets the data traffic path with the gateway (the specific user plane network function unit 32) and sets a wireless data channel with the UE (S620) and then transfers the service permission message to the UE (S630).

The UE receives the service permission message and then configures data to be transmitted in an IP packet by using an allocated IP address, and transmits the data by using the set traffic path.

In accordance with a service activation procedure as described above, the traffic path is set through the network slice formed by the shared control plain network function unit 20, the specific control plane network function unit 31, and the specific user plane network function unit 32 corresponding to a service type to be provided, and thus the UE is provided with data according to a service through the corresponding traffic path.

For example, in a case where the UE is provided with a first service (e.g.: a large capacity mobile Internet service), in a core network slice formed by the first shared control plain network function unit 21, the first specific control plane network function unit 31a, the first specific user plane network function unit 31b, the second specific control plane network function unit 32a, and the second specific user plane network function unit 32b, a traffic path is set through a service operator network slice of the first specific control plane network function unit 31a and the first specific user plane network function unit 31b corresponding to the first operator, and thus the UE is provided with data according to a service through the corresponding traffic path.

Also, in a case where the UE is provided with a second service (e.g.: a low latency Internet service), in a core network slice formed by the second shared control plain network function unit 22, the first specific control plane network function unit 31c, the first specific user plane network function unit 31d, the second specific control plane network function unit 32c, and the second specific user plane network function unit 32d, a traffic path is set through a service operator network slice of the first specific control plane network function unit 31c and the first specific user plane network function unit 31d corresponding to the first operator, and thus the UE is provided with data according to a service through the corresponding traffic path.

According to such an exemplary embodiment of the present invention, a logical dedicated network suitable for a characteristic of each service may be configured in order to effectively support various services such as a large scale thing Internet service, a large capacity mobile Internet service, a low latency Internet service, etc. The logical dedicated network has the following merits compared to the conventional mobile communication network.

First, efficiency of a data path is achieved. A logical dedicated network suitable for a characteristic of each service may be configured, and a network slice supporting the same service may be locally changed according to a movement of user equipment, thereby making it possible to configure an efficient data path. This may reduce inefficient use of network resources.

Second, efficiency of network slice control is achieved. In a case where a service type desired by user equipment is different from an allocated network slice type, the load of a core network is reduced by minimizing control processing in the core network.

Third, a B2B (business to business) service market is activated. A network slice may be defined for each service provider and various B2B services may be provided. In the mobile communication network according to an exemplary embodiment of the present invention, a network slice may be provided for each application service operator, a dedicated network for an individual service (e.g., YouTube service, Netflix service, power grid service, etc.) of a service operator may be constructed, and thus various B2B service markets may be activated.

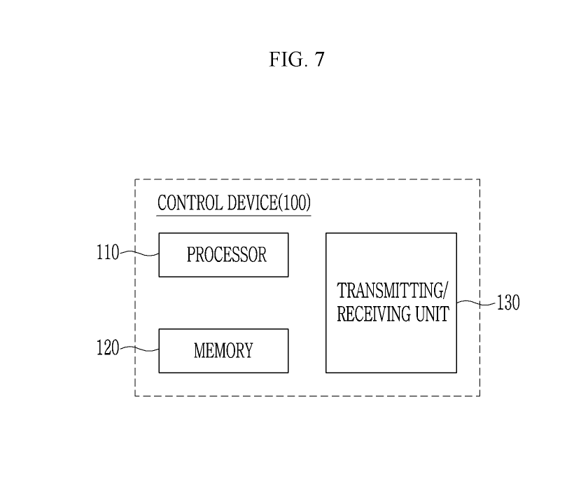

FIG. 7 is a diagram of a structure of a control device 100 of a mobile communication network system according to another exemplary embodiment of the present invention.

As shown in the attached FIG. 7, the control device 100 of the mobile communication network system according to another exemplary embodiment of the present invention includes a processor 110, a memory 120 and a transmitting/receiving unit 130. The processor 110 may be configured to implement the methods described with reference to FIGS. 2 to 6 above. For example, the processor 110 may be configured to perform a data transfer function, an UE management function, a network slice selection function, an UE and service authentication function, a session and QoS control function, a session continuity control function, and a subscriber and QoS information management function. Also, the processor 110 may be configured to form at least one of a shared control network function unit, a shared control plane network function unit, and a specific network function unit based on the above functions and perform a function of the at least one unit.

The memory 120 is connected with the processor 110 and stores various information relating to an operation of the processor 110. The memory 120 may store instructions to be performed in the processor 110 or load instructions from a storage device (not shown) and temporally store the instructions. The processor 110 may execute the instructions stored or loaded in the memory 120. The processor 110 and the memory 120 may be connected with each other via a bus (not shown), and an input/output interface (not shown) may be connected with the bus.

The transmitting/receiving unit 130 may be configured to perform signal transmitting/receiving.

According to an exemplary embodiment of the present invention, a mobile communication network system may configure a logical dedicated network suitable for a characteristic of each service, thereby effectively supporting services such as a large scale thing Internet service, a large capacity mobile Internet service, and a low latency internet service, etc.

The exemplary embodiment of the present invention is not implemented through the above-described device and/or methods but may be implemented through a program for realizing functions corresponding to the configuration of the exemplary embodiment of the present invention, and a recording medium on which the program is recorded, and such an embodiment can be easily implemented by those of ordinary skill in the art from the description of the exemplary embodiments above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile communication network system comprising:
a default network slice;
at least one core network slice added according to a supporting service; and
at least one service operator network slice added according to a service operator in the core network slice,
wherein the core network slice is determined according to a service type required by user equipment, and the service operator network slice is determined by the core network slice.

2. The mobile communication network system of claim 1, wherein:
in a case where the user equipment requires a first service and a second service, a first core network slice according to a type of the first service and a second core network slice according to a type of the second service are configured.

3. The mobile communication network system of claim 1, wherein:
the default network slice determines a core network slice corresponding to a service type required by the user equipment among a plurality of core network slices, and
the core network slice determines a service operator network slice corresponding to the service type required by the user equipment among a plurality of service operator network slices.

4. The mobile communication network system of claim 1, wherein:
the default network slice performs a user equipment management function of authenticating whether a network access of the user equipment is allowed when the user equipment firstly accesses, a network slice selection function of selecting a network slice type to be used by the user equipment, and an authentication function of allocating an ID and an IP address to be used by the user equipment.

5. The mobile communication network system of claim 4, wherein:
the default network slice selects one core network slice from among a plurality of core network slices according to a service type required by the user equipment that accesses, determines a temporary ID with respect to the user equipment according to identification information of the selected core network slice, allocates an IP address to be used when the user equipment transmits a data packet, and transmits an access permission message to the user equipment.

6. The mobile communication network system of claim 5, wherein:
the access permission message includes identification information of the default network slice to which the user equipment is accessed, identification information of the selected core network slice, the temporary ID, the IP address, and authentication related information.

7. The mobile communication network system of claim 1, wherein:
the core network slice performs a user equipment management and authentication function of managing the user equipment that accesses and authenticating a service use authorization, and, in a case where the user equipment has the service use authorization, a network slice selection function of selecting one service operator network slice from a plurality of service operator network slices.

8. The mobile communication network system of claim 1, wherein:
the service operator network slice includes a specific control plane network function unit performing a session and QoS (Quality of Service) control and a specific user plane network function unit performing a data transfer.

9. The mobile communication network system of claim 8, wherein:
according to a data traffic path setting request of the core network slice for the user equipment, the specific control plane network function unit sets a data traffic path with the specific user plane network function unit based on location information of a base station to which the user equipment is accessed.

10. The mobile communication network system of claim 1, wherein:
a core network slice supporting the same service is changed according to a movement of the user equipment.

11. A control method of a mobile communication network system, the control method comprising:
a control device that is a default network slice of the mobile communication network system determining a network slice corresponding to a service type required by a user equipment; and
the control device transmitting a message including identification information of the selected network slice to the user equipment,
wherein the network slice includes a core network slice corresponding to the service type and further includes a service operator network slice in the core network slice.

12. The control method of claim 11, wherein:
the determining of the network slice includes,
the control device authenticating whether a user of the user equipment is a subscribed allowed to access; and
in a case where the user of the user equipment is the subscribed allowed to access, the control device selecting a core network slice corresponding to a service type required by the user equipment.

13. The control method of claim 12, wherein:
the transmitting of the message to the user equipment includes:
the control device determining a temporary ID of the user equipment according to identification information of the selected core network slice and allocating an IP address to be used when the user equipment transmits a data packet; and
the control device transmitting a message including identification information of the default network slice to which the user equipment is accessed, identification information of the selected core network slice, the temporary ID, the IP address, and authentication related information.

14. The control method of claim 13, further comprising:
before the determining of the network slice,
in a case where identification information of the user equipment that accesses is the temporary ID and the identification information of the default network slice provided from the user equipment is not identical to the identification information of the default network slice corresponding to the control device, the control device receiving a service request message with respect to the user equipment from the base station,
wherein a network slice with respect to the user equipment is re-determined.

15. A control method of a mobile communication network system, the control method comprising:
a control device corresponding to a core network slice of the mobile communication network system authenticating whether a user equipment has a service use authorization;
in a case where the user equipment has the service use authorization, the control device selecting one service operator network slice from a plurality of service operator network slices;
the control device requesting a data traffic path setting with respect to the user equipment from the selected service operator network slice; and
the control device transmitting information about a data traffic path set according to a request to the user equipment.

16. The control method of claim 15, wherein:
the service operator network slice includes a specific control plane network function unit performing a session and QoS control and a specific user plane network function unit performing a data transfer.

17. The control method of claim 16, wherein:
the requesting of the data traffic path setting includes;
the specific control plane network function unit of the service operator network slice receiving a data traffic path setting request;
the specific control plane network function unit selecting one specific user plane network function unit from a plurality of specific user plane network function units based on location information of a base station to which the user equipment is accessed; and
the specific control plane network function unit setting a data traffic path with the selected specific user plane network function unit.
